(19) United States
(12) Patent Application Publication
(10) Pub. No.: US 2004/0030946 A1
(43) Pub. Date: Feb. 12, 2004

(54) Clock distributor circuit for maintaining a phase relationship between remote operating nodes and a reference clock on a chip

(76) Inventor: Adam L. Carley, Windham, NH (US)

Correspondence Address: Brian M. Dingman, Mirick, O'Connell, DeMallie & Lougee, LLP, 1700 West Park Drive, Westborough, MA, 01581, US

(21) Appl. No.: 10/636,863

(22) Filed: Aug. 7, 2003

Related U.S. Application Data
(60) Provisional application No. 60/402,031, filed on Aug. 8, 2002.

(51) Int. Cl. G06F 1/04

(52) U.S. Cl. 713/500

(57) ABSTRACT

A clock signal distributor circuit for maintaining a phase relationship between one or more remote operating nodes and a reference clock on a chip, wherein there is a clock signal drive path and a clock signal sense path in a distribution limb for each remote node. The clock signal distributor circuit comprises a variable signal delay circuit in the clock signal drive path, a variable signal delay circuit in the clock signal sense path, and a feedback circuit that causes at least one variable signal delay circuit to change its signal delay based on the sense path.

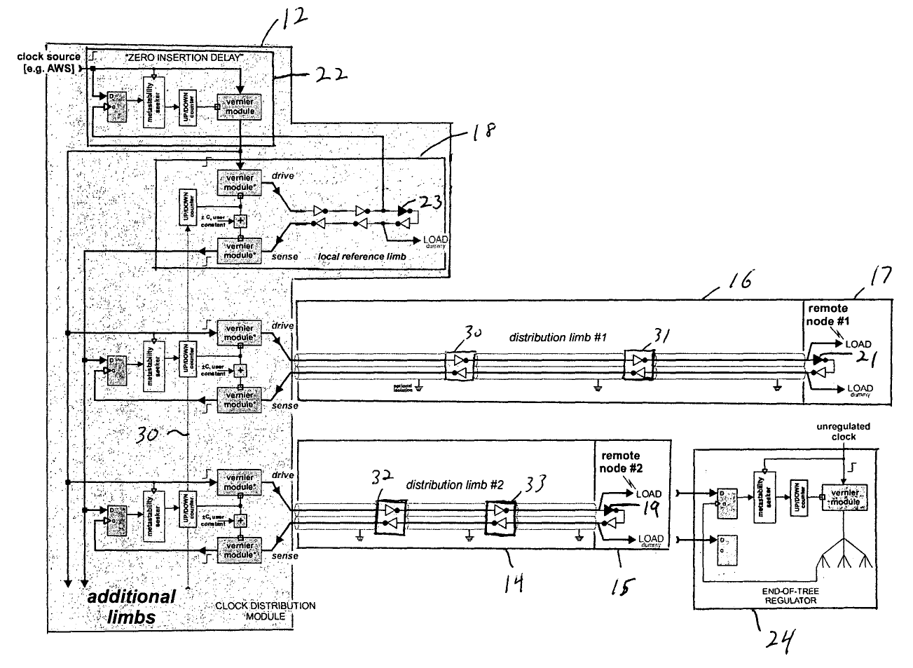

### CROSS REFERENCE TO RELATED APPLICATION

This application claims priority of Provisional application serial No. 60/402,031, filed on Aug. 8, 2002.

### FIELD OF THE INVENTION

This invention relates to a clock tree for large integrated circuits. The clock tree has very low skew across its end points and yet can be easily implemented without extensive layout trialand-error. The circuit dynamically corrects for temperature, process, layout, load, and voltage variations including variations within a single chip.

### BACKGROUND OF THE INVENTION

The concept is well known in the prior art of sensing a clock phase at a sense point in a signal path and feeding it back to maintain that point in an exact phase relationship to a reference. However, when the end point is remote, the delay in the sense signal itself introduces an error comparable to the one being corrected.

### SUMMARY OF THE INVENTION

The inventive circuit has two variable delays for each distribution limb, not one. The variable delays may be accomplished with vernier modules. A feedback circuit adjusts the delay in the sense path simultaneously with the delay in the feed path. The vernier modules are adjacent to each other on the chip and neither is remote. They will thus track accurately. Then, even though the propagation delay from the central module to the remote node is unknown, the remote node will assume a phase exactly halfway between two points in the clock distribution module. This algebraic fact makes it possible to lock all the remote nodes, no matter how different, with nearly zero skew with respect to each other and the source clock.

The following are key concepts relating to the invention. These concepts apply to a clock distributor circuit for maintaining a phase relationship between remote operating nodes and a reference clock on a chip.

1. Routing the sense line and feed lines adjacent to one another to have almost exactly matched propagations, even though both are unknown and vary with conditions.

2. Compensating the propagation of the sense and feed lines in unison so that each remote node remains halfway between, or at least a predictable offset from halfway between, the timing at two points co-located in the control module.

3. Using the point of metastability in a latch as a precise phase detector.

4. Using phase compensation so fine that the system can be allowed to “hunt” continually +/− one vernier LSB.

5. Having all verniers, plus a dummy limb, at a single location on the chip to provide immunity to intra-chip process, voltage and temperature variations.

6. Placing a dummy load at the head of each sense path to provide insensitivity to variations in the real load.

7. Zero insertion delay combined with the above.

8. Sufficient accuracy to be able to cascade the process at least once.

9. A simple user phase adjustment for each limb that tracks with temperature/process/and voltage.

10. The compensated capacitance ladder, as describe above, used in the vernier.

This invention features a clock signal distributor circuit for maintaining a phase relationship between one or more remote operating nodes and a reference clock on a chip, wherein there is a clock signal drive path and a clock signal sense path in a distribution limb for each remote node. The clock signal distributor circuit comprises a variable signal delay circuit in the clock signal drive path, a variable signal delay circuit in the clock signal sense path, and a feedback circuit that causes at least one variable signal delay circuit to change its signal delay based on the sense path signal.

The variable signal delay circuits may comprise vernier modules. The vernier modules may comprise tapped delay chains; capacitance ladders comprising a plurality of capacitances, in which case the capacitance ladders may comprise a pair of capacitances making up each capacitance in the ladder, with only one of any pair in use at a time; or may comprise multiple, mutually exclusive paths having different capacitances or drive strengths.

The signal delay circuits are preferably physically adjacent to one another on the chip. The drive path and sense path for a distribution limb are preferably routed adjacent to one another on the chip. The drive path and sense path for any distribution limb are preferably the same length as one another. Alternatively, the drive and sense paths in all distribution limbs may be unequal by an amount of signal propagation time that is the same for all distribution limbs. The clock signal distributor circuit may further comprise signal buffers located in the drive path and the sense path for at least one distribution limb.

The clock signal distributor circuit may further comprise a dummy load operatively connected to the sense path of at least one distribution limb. The clock signal distributor circuit may still further comprise a local reference limb comprising a clock signal drive path and a clock signal sense path. The feedback-based means may in this case comprise means for comparing the clock phase of the sense path of the reference limb to the clock phase of the sense path of a distribution limb. The signal propagation time in the reference limb is preferably at least as long as that in any distribution limb.

The feedback-based means may further comprise means, responsive to the means for comparing, for causing the change only after a plurality of phase comparisons. The feedback-based means may further comprise means for providing for manual fine adjustment of the clock phase in a distribution limb. The feedback-based means preferably compensates the propagation of the drive and sense paths simultaneously. The feedback-based means may comprise an up/down counter. The feedback-based means may further comprise means for causing the variable signal delay circuits to continuously hunt back-and-forth around the point of maximum metastability. The clock signal distributor circuit may further comprise a zero insertion delay module that creates an effective negative delay in the clock signal before it is provided to the distribution limbs.

### BRIEF DESCRIPTION OF THE DRAWING

Other objects, features and advantages will occur to those skilled in the art from the following description of the preferred embodiment and the accompanying drawing, which is a schematic diagram of an embodiment of the clock distributor circuit of this invention.

### DESCRIPTION OF THE PREFERRED EMBODIMENTS

The preferred embodiment of the invention is depicted in the figure. The following description includes various alternative preferences for different portions of the circuit depicted in the figure.

### Functional Units

The inventive clock distributor consists of four units as shown in the figure.

1. The clock distribution module 12. This is the main module, preferably accomplished in a small hard-macro. It is located at a single position on the chip and sends out distribution limbs to remote areas of the chip. Two limbs 14, 16 are shown. There can be any number of limbs. The module is designed modularly, as shown, to be automatically configurable for any desired number of limbs. The local reference limb 18, described below, is part of the clock distribution module 12 and located within it.

2. The distribution limbs 14, 16. These limbs connect the clock distribution module 12 to the remote nodes 15, 17, which it maintains at almost exactly equal clock phase. Each limb consists of two counter-flowing paths, a feed (i.e. drive) path and a sense path.

3. Zero insertion delay 22. This is an optional module within the clock distribution module 12. It maintains the phase of the remote nodes 15, 17 not only equal to each other, but also very nearly equal to the source clock. If the source clock has adjustable phase, this module may not be needed. It creates an effective negative delay by delaying into the next complete (or later) cycle

4. End-of-tree regulator 24. The chip designer may use this phase-locked remote node three ways:

(a) It may directly drive a load, such as a local clock tree of known insertion delay.

(b) It may drive another complete clock distributor circuit of the invention, which in turn fans out to its own limbs, or

(c) It may drive a local clock tree through an end-of-tree regulator 24, as shown, which maintains essentially zero-insertion delay to a single selected sense point at the end of that local tree.

### Equalizing Drive and Sense Paths

For the “halfway” scheme of the invention to work, the drive path to a given remote node must precisely equal the returning sense path. The layout of these paths could be accomplished by hand, but preferably a special feature in the routing tool would be supplied to automatically equalize the feed and sense signal paths. The differential routing capability of a layout tool such as Astro™ from Synopsys can be used for this purpose.

Long distribution paths require amplification along the way. The back-to-back inverters (30, 31, 32, 33) shown along the limbs perform this function. These preferably would be distributed as hard macros to improve matching. For example, parasitic coupling to overpassing metal layers could be standardized and some power-supply isolation provided. (See voltage reference, below). There is no requirement that all limbs have the same number of amplifier stages, but their number in each limb must be even as shown.

The actual traces for the distribution limb would preferably be placed parallel to each other on one metal layer. Special attention (by the tool) would be paid to bends and vias to other metal layers. Grounded traces would isolate the sense and drive traces from each other and nearby circuitry. However, it would not matter if the delay through a given leg were an arbitrary mix of simple capacitive, RC, or transmission line effects. Nor would it matter if legs on different limbs or different legs on the same limb were different. All those effects get nulled out by the feedback circuits.

The “dummy load” system shown allows loads on different remote nodes to be different and to vary with local temperature, process, and supply voltage without creating clock skew. The load is effectively on the drive path and the nearby, matched, dummy load is on the sense path. For example if the load were a local clock tree, the root of that tree would be duplicated for the dummy load.

There can one particular type of deviation from the basic “halfway” scheme without creating clock skew. If drive and sense paths are unequal by an amount (of time) that is the same for all limbs, clock skew will still be virtually zero. That amount of time can vary with temperature, process, and voltage provided it tracks reasonably across all limbs. An example of this is inverters 19, 21 and 23. The true halfway point is in the middle of these inverters, not at the loads. The effect of this is to shift all nodes, including the local reference node, by half the propagation through one such inverter. But these inverters are in different regions of the chip, and therefore may see process variations. However, they are lightly loaded, very fast, and driving a falling edge. Hence their process variation is a variation around a small number and likely to be miniscule, e.g. a few picoseconds or less.

There are also non-halfway contributions due to end effects at the drive ends of the distribution limbs. However, these are all located locally in the clock distribution module and therefore will be very similar from one limb to another and contribute nothing to the skew.

### Logic in Clock Distribution Module

The clock phase returning from each limb is compared to that from the local reference limb 18. The comparisons may be either binary (early/late) or have hysteresis (early/hold/late). If the limb signal is early, its UP/DOWN counter is increased by one, increasing the delay in both drive and sense paths. If the limb signal is late, the counter is decreased by one. The size of a single LSB of the count is selected to be much smaller than the desired skew error of the system.

Since negative delays are impossible, the local reference limb 18 must be equal or longer than the longest remote limb. This condition can be achieved in one of two ways:

(a) The local reference limb can be hand selected to be longer than any remote limb under all circumstances. This would eliminate its two vernier modules, as well as the UP/DOWN counter driving them, and replace them with fixed delays. However, it involves a hand design step.

(b) The condition can be guaranteed automatically and dynamically by the dotted circuit 30. Whenever a remote limb UP/DOWN counter tries to go negative, the local reference limb counter and the other remote limb counters are incremented instead. Conversely, if any counter tries to overflow the others are decremented.

The zero insertion delay module 22 is basically a delay-locked-loop that effectively creates a negative delay by adding a positive delay all the way into the next cycle, or possibly the 3^{rd} or 4^{th} cycles in the future for many-tiered clock trees. The metastability-seeking circuit described below allows this to lock to high accuracy, i.e. negligible skew. The vernier in the zero insertion delay module 22 is not necessarily identical to the others. It may, for example, require more range.

Each of the limbs is also provided with a manual fine-adjustment, C₀, C₁, C₂, etc. These are very fine adjustments with half the granularity of the vernier. Adjustment may be either forward or backward in phase. The C's are two's complement signed numbers (e.g. 8-bit) that may be left zero, hardwired at layout time, or downloaded from software. C₀ moves all remote limbs together with respect to the input reference clock. The vernier modules in the clock distribution module 12 (with the exception of the vernier module in the zero insertion delay module 22) preferably have their inputs and outputs impedance matched to the repeaters in the distribution limbs.

### Startup

To minimize any startup transient, the UP/DOWN counters can begin at preset values selected based on simulation. However, for complex chips the clock skew may not be low enough for the chip to be operative immediately. In that case, a special time period must be set aside during reset for the clock skews to be adjusted before the chip is released into operation. Chips that can recover on the fly from errors (i.e. that cannot hang) do not require this special interval. Also, if necessary, more complicated proportional (rather than binary) phase detectors will speed up the process.

### Phase Detectors

Binary phase detectors are required in many circuits and appear in various prior art. Some prior art designs start with similar detector elements to that used here, e.g. transparent latches, but then often make a special effort to avoid metastability and hence end up with a dead zone, or hysteresis greater than the few picoseconds accuracy achieved here.

The circuit shown exploits rather than avoids metastability as follows:

The variables being compensated for are slowly varying. It is permissible to take many clock cycles before deciding whether to increase or decrease an UP/DOWN counter. The “metastability-seeker” circuit takes a number of phase readings, e.g. 32, before changing anything. It may allow each a settle time of two or three clocks (to be determined by simulation). The circuit seeks the point of maximum metastability, which is a very narrow region in time. At maximum metastability, the readings will split 50-50 between “lead” and “lag” indications. Stated more precisely, the 50-50 point is defined to be the metastability point that is sought. Whether the result is above or below 50-50 determines the output. If a “hold” band is desired, then some range around 50-50 must be exceeded before there is any action. The best results will be achieved if there is no hold band and the vernier hunts back-and-forth by one count of a few picoseconds.

Such a high-precision phase detector is necessarily a noise amplifier. This effect can be minimized by having the readings unequally spaced in time to cancel coherent circuit noise. A preprogrammed pseudorandom spacing would preferably be used.

Note that any systematic error or skew in the phase detector elements doesn't matter because it will affect all limbs equally in the design shown. There is likely an advantage to designing the detectors as custom cells.

### Vernier Modules

There are several possible types of programmed delay circuits:

(a) Tapped delay chain. A selector selects a delay of n units down a chain of N active delay elements each consisting, for instance, of a buffer gate. If laid out symmetrically, this arrangement is very linear and monotonic but has large steps.

(b) Capacitance ladder. A subset of a set of N capacitance loads is switched onto a signal to delay it. Each step adds one more cap, leaving the others in place. Passgates are used to connect in the capacitors. This is monotonic and has fine steps, but the steps are not arbitrarily fine because even if a zero capacitance is switched in there will be parasitic capacitance switched in with it. It is easy to make the error of thinking this is also perfectly linear if the capacitors are identical. In fact it is highly non-linear because the current driver turn-on is gradual on the time-scale that matters. (Direction of nonlinearity: the first capacitor switched in has to be a lot larger than the last.) The capacitance ladder can be hand-linearized by choosing capacitances based on simulation.

(c) Path selection. This is the only method allowing arbitrarily small steps. Multiple paths are mutually-exclusively selected by a balanced MUX circuit. Each is separately tuned with added capacitance based on simulation. Each capacitor has its own isolated driver. Alternatively, in a circuit similar to the capacitance ladder, capacitors driven by a single source can be selected with passgates. Only one capacitor is selected at a time. Linearity is guaranteed only if the capacitances have been selected properly. It may degrade with process if extremely fine steps are created.

(d) Compensated Capacitance ladder. This is a hybrid of (b) and (c) that guarantees monotonicity but can have arbitrarily fine steps. Each passgate in the capacitance ladder is actually a carefully matched identical pair of passgates, one of which drives nothing. Only one member of each pair is on at a time. A given rung on the ladder can then add an arbitrarily small capacitance load to the total without considering the parasitic capacitance of a passgate, which is present whether the cap is selected or not.

For the clock distributor, 128 or 256 vernier steps would probably be desired. Linearity is not an issue because feedback adjusts the circuit until the delay is right. Monotonicity and small steps, however, are required. One design uses two stages of different pitch, for example an 8:1 tapped delay chain followed by a 32:1 path selector.

Other embodiments will occur to those skilled in the art and are within the following claims.

What is claimed is:

1. A clock signal distributor circuit for maintaining a phase relationship between one or more remote operating nodes and a reference clock on a chip, wherein there is a clock signal drive path and a clock signal sense path in a distribution limb for each remote node, the clock signal distributor circuit comprising:
a variable signal delay circuit in the clock signal drive path;
a variable signal delay circuit in the clock signal sense path; and
feedback-based means for causing at least one variable signal delay circuit to change its signal delay based on the sense path signal.

2. The clock signal distributor circuit of claim 1 wherein at least one of the variable signal delay circuits comprises a vernier module.

3. The clock signal distributor circuit of claim 1 wherein the variable signal delay circuits are physically adjacent to one another on the chip.

4. The clock signal distributor circuit of claim 1 wherein the drive path and sense path for a distribution limb are routed adjacent to one another on the chip.

5. The clock signal distributor circuit of claim 4 wherein the drive path and sense path for a distribution limb are the same length.

6. The clock signal distributor circuit of claim 5 wherein the drive paths and sense paths in any one of the distribution limbs are the same length as one another.

7. The clock signal distributor circuit of claim 1 further comprising means located in the drive path and the sense path for at least one distribution limb, for buffering the drive and sense signals.

8. The clock signal distributor circuit of claim 1 further comprising a dummy load operatively connected to the sense path of at least one distribution limb.

9. The clock signal distributor circuit of claim 1 wherein the drive and sense paths in all distribution limbs are unequal by an amount of signal propagation time that is the same for all distribution limbs.

10. The clock signal distributor circuit of claim 1 further comprising a local reference limb comprising a clock signal drive path and a clock signal sense path.

11. The clock signal distributor circuit of claim 10 wherein the feedback-based means comprises means for comparing the clock phase of the sense path of the reference limb to the clock phase of the sense path of a distribution limb.

12. The clock signal distributor circuit of claim 10 wherein the signal propagation time in the reference limb is at least as long as that in any distribution limb.

13. The clock signal distributor circuit of claim 11 wherein the feedback-based means further comprises means, responsive to the means for comparing, for causing the change only after a plurality of phase comparisons.

14. The clock signal distributor circuit of claim 13 wherein the feedback-based means further comprises means for providing for manual fine adjustment of the clock phase in a distribution limb.

15. The clock signal distributor circuit of claim 1 wherein the feedback-based means compensates the propagation of the drive and sense paths simultaneously.

16. The clock signal distributor circuit of claim 15 wherein the feedback-based means comprises an up/down counter.

17. The clock signal distributor circuit of claim 11 wherein the feedback-based means further comprises means for causing the variable signal delay circuits to continuously hunt back-and-forth around the point of maximum metastability.

18. The clock signal distributor circuit of claim 1 further comprising a zero insertion delay module that creates an effective negative delay in the clock signal before it is provided to the distribution limbs.

19. The clock signal distributor circuit of claim 2 wherein at least one vernier module comprises a tapped delay chain.

20. The clock signal distributor circuit of claim 2 wherein at least one vernier module comprises a capacitance ladder comprising a plurality of capacitances.

21. The clock signal distributor circuit of claim 20 wherein the capacitance ladder comprises a pair of capacitances making up each capacitance in the ladder, with only one of any pair in use at a time.

22. The clock signal distributor circuit of claim 2 wherein at least on vernier module comprises multiple, mutually exclusive paths having different delays.

23. A clock signal distributor circuit for maintaining a phase relationship between one or more remote operating nodes and a reference clock on a chip, wherein there is a clock signal drive path and a clock signal sense path in a distribution limb for each remote node, the clock signal distributor circuit comprising:
a first variable signal delay vernier module in the clock signal drive path and at a physical location on the chip;
a second variable signal delay vernier module in the clock signal sense path and at a physical location on the chip adjacent to the location of the first vernier module; and
feedback-based means for causing the first and second vernier modules to simultaneously change their signal delay based on the sense path;
wherein the drive path and sense path for a distribution limb are routed adjacent to one another on the chip.

24. The clock signal distributor circuit of claim 23 further comprising a local reference limb comprising a clock signal drive path and a clock signal sense path.

25. The clock signal distributor circuit of claim 24 wherein the feedback-based means comprises means for comparing the clock phase of the sense path of the reference limb to the clock phase of the sense path of a distribution limb.

26. The clock signal distributor circuit of claim 25 wherein the feedback-based means further comprises means, responsive to the means for comparing, for causing the change only after a plurality of phase comparisons.

27. The clock signal distributor circuit of claim 26 wherein the feedback-based means further comprises means for providing for manual fine adjustment of the clock phase in a distribution limb.

28. The clock signal distributor circuit of claim 24 wherein the signal propagation time in the reference limb is at least as long as that in any distribution limb.
